(19) United States
(12) Patent Application Publication
(10) Pub. No.: US 2010/0112322 A1
(43) Pub. Date: May 6, 2010

(54) CARBON FIBERS AND FILMS AND METHODS OF MAKING SAME

(75) Inventors: Satish Kumar, Lawrenceville, GA (US); Han Gi Chae, Atlanta, GA (US)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: GEORGIA TECH RESEARCH CORPORATION, Atlanta, GA (US)

(21) Appl. No.: 12/525,293

(22) PCT Filed: Jan. 30, 2008
(86) PCT No.: PCT/US2008/052471

§ 371 Date: Jul. 30, 2009

Related U.S. Application Data
(60) Provisional application No. 60/887,175, filed on Jan. 30, 2007.

(51) Int. Cl. B29C 47/88; D01F 9/12; B32B 9/00; B32B 5/02

(52) U.S. Cl. 428/220; 264/211.12; 264/29.1; 264/29.2; 428/367; 977/742; 977/840

(57) ABSTRACT

The various embodiments of the present invention provide improved carbon fibers and films, as well as methods of making the carbon fibers and films. The carbon fibers and films disclosed herein are generally formed from an acrylonitrile-containing polymer. The carbon fibers and/or films can also be formed from a composite that includes the acrylonitrile-containing polymer as well as carbon nanotubes, graphite sheets, or both. The fibers and films described herein can be tailored to exhibit one or more of high strength, high modulus, high electrical conductivity, high thermal conductivity, or optical transparency, depending on the desired application for the fibers or films.

### CROSS-REFERENCE TO RELATED APPLICATIONS

This application claims the benefit of U.S. Provisional Patent Application No. 60/887,175, filed 30 Jan. 2007, which is incorporated herein by reference in its entirety as if fully set forth below.

### STATEMENT OF FEDERALLY SPONSORED RESEARCH

This invention was made with United States Government support under Grant Nos. FA9550-06-1-0122 and FA9550-07-1-0233, both awarded by Air Force Office of Scientific Research. The United States Government has certain rights in this invention.

### TECHNICAL FIELD

The various embodiments of the present invention relate generally to carbon fibers and films, and more particularly, to carbon fibers and films formed from acrylonitrile-containing polymers, and methods of making the carbon fibers and films.

### BACKGROUND

Polymers containing acrylonitrile are important commercial polymers for use in fibers for such applications as fabrics, carpets, and carbon fibers. High performance acrylic fibers produced from polyacrylonitrile copolymers are currently the predominant precursors for carbon fibers, in part because polyacrylonitrile-based carbon fibers exhibit good tensile and compressive properties. Further, the carbon yield of polyacrylonitrile-based carbon fibers can be quite high.

CNTs can be thought of as the ultimate carbon fiber because their ideal graphitic structure and alignment with respect to each layer gives them exceptional engineering properties (e.g., high tensile strength, high modulus, and high thermal and electrical conductivities) and light weight. The translation of these properties into larger structures, however, has been a challenge. Early difficulties incorporating CNTs into other materials were due to an inability to disperse the nanotubes. These problems associated with dispersing carbon nanotubes are due largely to their insolubility in most common solvents and their propensity to rope together in CNT bundles and be held tightly together by van der Waals forces.

Recently, methodologies have been developed to produce nanotube-containing polymer composites, and, in particular, carbon fibers containing single wall carbon nanotubes (SWNTs), wherein the SWNTs are well dispersed in the composite. For example, U.S. Pat. No. 6,852,410, the entire contents of which are incorporated herein by reference as if fully set forth below, discloses such methods. Among other improvements, these methods provide composite fibers with increased tensile modulus and strength. As new applications continue to open up, however, so to does the need for improved materials.

Accordingly, there is a need for new carbon fibers and carbon films that exhibit increased tensile modulus and strength. There is also a need for new methods of making the carbon fibers and films. It is to the provision of such materials and methods that the various embodiments of the present invention are directed.

### BRIEF SUMMARY

The various embodiments of the present invention are directed to carbon fibers and films, and methods of making the carbon fibers and films. The high strength and high modulus fibers and films can be useful in a variety of applications, including, but not limited to, material reinforcement (e.g., in tire cord and in cement), aircraft parts, body panels for high-performance vehicles (e.g., formula one race cars and motorcycles), sporting equipment (e.g., bikes, golf clubs, tennis rackets, and skis), and other demanding mechanical applications. Owing to their electrical and thermal conductivities, these carbon films and fibers can also find applications in electronic devices, fuel cells, electrochemical capacitors, and the like.

Broadly described, methods for making carbon fibers according to various embodiments of the present invention include gel-extruding an acrylonitrile-containing polymer to form a polymer fiber precursor, drawing the polymer fiber precursor to form a drawn polymer fiber, and stabilizing the drawn polymer fiber. The stabilizing can be accomplished under tension, and/or in an oxidizing environment, and/or at about 200 degrees Celsius to about 400 degrees Celsius for less than or equal to about 36 hours.

The methods can also include carbonizing the stabilized polymer fiber. The carbonizing can be accomplished under tension, and/or in an inert environment, and/or at about 500 degrees Celsius to about 1800 degrees Celsius for less than or equal to about 2 hours. Still further, the methods can also include graphitizing the carbonized polymer fiber. The graphitizing can be accomplished under tension, and/or in a non-nitrogen-containing inert environment, and/or at about 1800 degrees Celsius to about 2800 degrees Celsius for less than or equal to about 1 hour.

After drawing, the drawn polymer fiber can have an average diameter of about 100 nanometers to about 100 micrometers. The final carbon fiber can have an average cross-sectional dimension of about 50 nanometers to about 50 micrometers.

Various other embodiments of the present invention are directed to methods of making carbon fibers or films containing carbon nanotubes (CNTs). These methods include contacting CNTs with an acrylonitrile-containing polymer to form a polymer-CNT dope, gel-extruding the polymer-CNT dope to form a polymer-CNT fiber or film precursor, drawing the polymer-CNT fiber or film precursor to form a drawn polymer-CNT fiber or film, and stabilizing the drawn polymer-CNT fiber or film. These methods can also include carbonizing the stabilized polymer-CNT fiber or film and/or graphitizing the carbonized polymer-CNT fiber or film. Such methods can produce carbon fibers or films that exhibit electrical conductivities at least 50% higher than those for carbon fibers or films containing no CNTs.

In specific embodiments, the CNTs can include single wall nanotubes, double wall nanotubes, triple wall nanotubes, or a combination having two or more of the foregoing types of CNTs. In some embodiments, the CNTs have an average diameter of about 0.5 nanometers to about 100 nanometers. In other embodiments, the CNTs have an average diameter less than or equal to about 10 nanometers. The CNTs can also have an average length of greater than or equal to about 10 nanometers. The CNTs can take up about 0.001 weight percent to about 40 weight percent of the dope, based on a total weight of the dope. Similarly, the CNTs can encompass about 0.001 weight percent to about 80 weight percent of the final carbon fiber or film, based on a total weight of the carbon fiber or film.

In some embodiments, the CNTs in the final carbon fibers or films are exfoliated. The carbon fibers or films can have a crystallized graphitic regions radially extending about 0.34 nanometers to about 50 nanometers from a wall of each CNT. In some embodiments, the crystallized graphitic regions radially extend at least about 2 nanometers from the wall of each CNT.

Other methods of making carbon fibers or films containing CNTs can include contacting CNTs with an acrylonitrile-containing polymer to form a polymer-CNT dope, extruding the polymer-CNT dope to form a polymer-CNT fiber precursor, drawing the polymer-CNT fiber precursor to form a drawn polymer-CNT fiber or film, stabilizing the drawn polymer-CNT fiber or film, and carbonizing the stabilized fiber or film so as to produce a carbon fiber having a crystallized graphitic region radially extending about 0.34 nanometers to about 50 nanometers from a wall of each CNT. Such methods can also include graphitizing the carbonized polymer-CNT fiber or film.

Other methods of making carbon fibers or films containing CNTs can include contacting CNTs with an acrylonitrile-containing polymer to form a polymer-CNT dope, such that the polymer-CNT dope includes about 1 weight percent CNT based on the weight of the polymer, extruding the polymer-CNT dope to form a polymer-CNT fiber or film precursor, drawing the polymer-CNT fiber or film precursor to form a drawn polymer-CNT fiber or film, stabilizing the drawn polymer-CNT fiber or film, and carbonizing the stabilized fiber effective to produce a carbon fiber or film having at least a 0.5 GPa greater tensile strength than a carbon fiber or film produced without the CNT. The carbon fiber or film can have at least a 50 GPa greater tensile modulus than a carbon fiber or film produced without the CNT. Such methods can also include graphitizing the carbonized polymer-CNT fiber or film.

Still other methods of making carbon fibers containing CNTs include contacting CNTs with an acrylonitrile-containing polymer to form a polymer-CNT dope, such that the polymer-CNT dope includes about 1 weight percent CNT based on the weight of the polymer, gel extruding the polymer-CNT dope to form a polymer-CNT fiber precursor, drawing the polymer-CNT fiber precursor to form a drawn polymer-CNT fiber, stabilizing the drawn polymer-CNT fiber under tension in air, and carbonizing the stabilized fiber under tension in an inert environment effective to produce a carbon fiber having at least an 0.7 GPa greater tensile strength and at least a 77 GPa greater tensile modulus than a carbon fiber produced without the CNT. These methods can also include graphitizing the carbonized polymer-CNT fiber.

In yet other methods of making carbon fibers containing CNTs, the methods include contacting CNTs with an acrylonitrile-containing polymer to form a polymer-CNT dope, such that the polymer-CNT dope includes about 1 weight percent CNT based on the weight of the polymer, gel extruding the polymer-CNT dope to form a polymer-CNT fiber precursor, drawing the polymer-CNT fiber precursor to form a drawn polymer-CNT fiber, stabilizing the drawn polymer-CNT fiber under tension in air, and carbonizing the stabilized fiber under tension in an inert environment effective to produce a carbon fiber having an average diameter less than or equal to about 10 micrometers. These methods can also include graphitizing the carbonized polymer-CNT fiber.

Various other embodiments of the present invention are directed to methods of making carbon fibers or films containing graphite sheets. These methods include contacting graphite sheets with an acrylonitrile-containing polymer to form a polymer-graphite sheet dope, extruding the polymer-graphite sheet dope to form a polymer-graphite sheet fiber or film precursor, drawing the polymer-graphite sheet fiber or film precursor to form a drawn polymer-graphite sheet fiber or film, and stabilizing the drawn polymer-graphite sheet fiber or film. These methods can also include carbonizing the stabilized polymer-graphite sheet fiber or film and/or graphitizing the carbonized polymer-graphite sheet fiber or film.

Various other embodiments of the present invention are directed to carbon fibers or films. The carbon fibers or films can be formed from CNTs and an acrylonitrile-containing polymer. These carbon fibers have average cross-sectional dimensions of about 50 nanometers to about 50 micrometers; the carbon films have average thicknesses of about 25 nanometers to about 250 micrometers. Crystallized graphitic regions radially extending about 0.34 nanometers to about 50 nanometers from the wall of each CNT can be found in the carbon fibers or films. In some embodiments, the crystallized graphitic region radially extends at least about 2 nanometers from the wall of each CNT. The carbon fibers or films can have exfoliated CNTs. The carbon fibers or films can exhibit electrical conductivities at least 25% higher than those for carbon fibers or films containing no CNTs. Depending on the particular dimensions of the fibers or films, in some embodiments they can be optically transparent.

The carbon fibers or films can have tensile strengths at least about 0.5 GPa greater than carbon fibers or films formed without CNTs. In some embodiments, the tensile strength of a carbon fiber is at least 0.7 GPa greater than for carbon fibers formed without CNTs. The carbon fibers or films can have tensile moduli at least about 50 GPa greater than carbon fibers or films formed without CNTs. In some embodiments, the tensile modulus of a carbon fiber is at least 77 GPa greater than for a carbon fiber formed without CNTs. In other embodiments, the carbon fiber has at least a 1.2 GPa greater tensile strength and at least a 148 GPa greater tensile modulus than a carbon fiber produced without the CNTs.

Various other embodiments of the present invention are directed to carbon fibers or films. The carbon fibers or films can be formed from graphite sheets and an acrylonitrile-containing polymer. These carbon fibers have average cross-sectional dimensions of about 50 nanometers to about 50 micrometers; the carbon films have average thicknesses of about 25 nanometers to about 250 micrometers. Crystallized graphitic regions radially extending about 0.34 nanometers to about 50 nanometers from the graphite sheets can be found in the carbon fibers or films. In some embodiments, the crystallized graphitic region radially extends at least about 2 nanometers from each graphite sheet. The carbon fibers or films can have exfoliated graphite sheets. The carbon fibers or films can exhibit electrical conductivities at least 25% higher than those for carbon fibers or films containing no graphite sheets. Depending on the particular dimensions of the fibers or films, in some embodiments they can be optically transparent.

Other aspects and features of embodiments of the present invention will become apparent to those of ordinary skill in the art, upon reviewing the following detailed description in conjunction with the accompanying figures.

### BRIEF DESCRIPTION OF THE DRAWINGS

FIGS. 1 (a) and (B) are process flow diagrams illustrating methods for making carbon fibers or films in accordance with some embodiments of the present invention.

FIG. 2 includes UV-Vis spectra and schematic illustrations of carbon nanotube orientation in PAN/CNT fibers at various draw ratios for 1 wt % CNT samples.

FIG. 3 includes G-band Raman spectra for a drawn PAN/CNT (1 wt %) fiber when the angle between the polarizer and the fiber axis are 0° and 90°.

FIG. 4 is a schematic illustration of an apparatus for inducing stress or tension in gel-spun PAN/CNT fibers during stabilization and carbonization.

FIG. 5 includes scanning electron microscope (SEM) images for large diameter (a) stabilized PAN and (b) stabilized PAN/CNT (99/1) fibers, and the (c) carbonized PAN and (d) carbonized PAN/CNT (99/1) fibers.

FIG. 6 includes (b) a schematic illustration of a PAN/CNT-based carbon fiber structure, as well as high resolution transmission electron microscope (HR-TEM) images of (a) and (c)-(f) various regions of carbonized PAN/CNT (99/1) fibers, and (g) carbonized PAN.

FIG. 7 includes Raman spectra, using a 785 nm laser, for (a) carbonized PAN and (b) carbonized PAN/CNT (99/1) fibers as a function of applied stress during stabilization and carbonization.

FIG. 8 includes a G-band Raman spectrum, using a 785 nm laser, of a gel extruded PAN/CNT (99/1) fiber precursor.

### DETAILED DESCRIPTION

Referring now to the figures, wherein like reference numerals represent like parts throughout the several views, exemplary embodiments of the present invention will be described in detail. Throughout this description, various components may be identified having specific values or parameters, however, these items are provided as exemplary embodiments. Indeed, the exemplary embodiments do not limit the various aspects and concepts of the present invention as many comparable parameters, sizes, ranges, and/or values may be implemented. The terms “first,” “second,” and the like, “primary,” “secondary,” and the like, do not denote any order, quantity, or importance, but rather are used to distinguish one element from another. Further, the terms “a”, “an”, and “the” do not denote a limitation of quantity, but rather denote the presence of “at least one” of the referenced item.

The carbon fibers and carbon films disclosed herein are formed from an acrylonitrile-containing polymer. In addition, the carbon fibers and/or carbon films optionally can be formed from a composite comprising the acrylonitrile-containing polymer and carbon nanotubes (CNTs). In other embodiments, the carbon fibers and/or films optionally can be formed from a composite comprising the acrylonitrile-containing polymer and individual graphite sheets. Incorporating CNTs and/or graphite sheets into the carbon fiber and/or film precursors results in carbon fibers and/or carbon films that exhibit many beneficial properties as will be described in more detail below.

Acrylonitrile-containing polymers can include copolymers containing an acrylonitrile monomer and another (i.e., at least one other) monomer. Thus, the term “copolymer” also includes terpolymers and other polymers having more than two different monomers. Examples of acrylonitrile-containing polymers include, but are not limited to, polyacrylonitrile (PAN), poly(acrylonitrile-methyl acrylate), poly(acrylonitrile-methacrylic acid), poly(acrylonitrile-acrylic acid), poly(acrylonitrile-itaconic acid), poly(acrylonitrile-methyl methacrylate), poly(acrylonitrile-itaconic acid-methyl acrylate), poly(acrylonitrile-methacrylic acid-methyl acrylate), poly(acrylonitrile-vinyl pyridine), poly(acrylonitrile-vinyl chloride), poly(acrylonitrile-vinyl acetate), and combinations thereof.

The relative amounts of co-monomer components in an acrylonitrile copolymer, as well as the molecular weight of the acrylonitrile-containing polymer, are dependent on the fiber or film properties desired. While different amounts can be used, preferably, the acrylonitrile monomer incorporation is greater than about 85 weight percent (wt %) based on the total weight of the overall acrylonitrile-containing polymer. Also, while other ranges can be used, the preferred molecular weight range of an acrylonitrile-containing polymer is about 50,000 grams per mole (g/mole) to about 2,000,000 g/mole, with 100,000 g/mole to about 500,000 g/mole even more preferred.

The carbon nanotubes can be any type of carbon nanotube, including single wall nanotubes (SWNTs), double wall nanotubes (DWNTs), triple wall nanotubes (TWNTs), multi-wall carbon nanotubes (MWNTs), or the like, or a combination including two or more of the foregoing types of carbon nanotubes (e.g., mixtures of SWNTs and DWNTs, mixtures of DWNTs and TWNTs, mixtures of SWNTs, DWNTs, and TWNTs, and the like). The CNTs can be tubular or collapsed nanotubes.

The carbon nanotubes can be made from any known means, including, but not limited to, gas-phase synthesis from high temperature, high pressure carbon monoxide, catalytic vapor deposition using carbon-containing feedstocks and metal catalyst particles, laser ablation, arc method, or any other method for synthesizing carbon nanotubes.

The CNTs obtained from synthesis are generally in the form of a powder, but can also be used in the form of carpets, forests, pearls, or like arrangements. The average diameter of the nanotubes can be about 0.5 nanometers (nm) to about 100 nm, with about 0.5 nm to about 25 nm being preferable. In some embodiments, it is desirable to use nanotubes having an average diameter of less than or equal to about 10 nm. The average length of the nanotubes can be greater than or equal to about 10 nanometers. For example, nanotubes having lengths on the order of millimeters or even centimeters could be used.

It is desirable for the CNTs to have a purity of at least 95 percent (%), and preferably at least 99%, in order to minimize the potential for adverse affects caused by impurities within the CNT sample. Thus, the CNTs can optionally be purified to remove non-nanotube carbon, such as amorphous carbon, and metallic catalyst residues.

Purification can be achieved by any known means. Procedures for purification of carbon nanotubes are well known to those skilled in the art to which this disclosure pertains. The optionally purified CNTs can also be dried. Similarly, procedures for drying are well known to those skilled in the art to which this disclosure pertains.

Further, the CNTs can be optionally derivatized on their ends and/or sides with a functional group. These functional groups can include an alkyl; acyl; aryl; aralkyl; halogen; substituted or unsubstituted thiol; substituted or unsubstituted amino; hydroxyl; an OR′ wherein R′ can include an alkyl, acyl, aryl, aralkyl, substituted or unsubstituted amino, substituted or unsubstituted thiol, and halogen; or a linear or cyclic carbon chain optionally interrupted with one or more heteroatom, and optionally substituted with one or more ═O, or ═S, hydroxyl, aminoalkyl group, amino acid, or a peptide. The extent of the substitution can be tailored to achieve the desired chemical effect, as would be understood to those skilled in the art to which this disclosure pertains. By way of one example, the number of carbon atoms in the alkyl, acyl, aryl, aralkyl groups can be in the range of 1 to about 30.

The CNTs can also optionally include non-carbon elements in the backbone. For example, elements such as boron, nitrogen, sulfur, silicon, or the like, can be included in the backbone of the CNTs depending on the particular application for the carbon fibers or films.

Similarly, the graphite sheets can be made from any known synthesis means. The average width of the graphite sheets can be about 0.5 nanometers (nm) to about 100 nm, with about 0.5 nm to about 25 nm being preferable. In some embodiments, it is desirable to use graphite sheets having an average width of less than or equal to about 10 nm. The average length of the graphite sheets can be greater than or equal to about 10 nanometers. For example, graphite sheets having lengths on the order of millimeters or even centimeters could be used.

In a similar fashion to the CNTs, the graphite sheets are desirably purified so as to minimize the potential for adverse affects caused by impurities within the graphite sample. Just as with the carbon nanotubes, the graphite sheets can be derivatized and/or include non-carbon elements in the framework. The optional derivatization and incorporation of non-carbon elements in the framework can be implemented in order to minimize the aggregation of the graphite sheets in the carbon fibers or films.

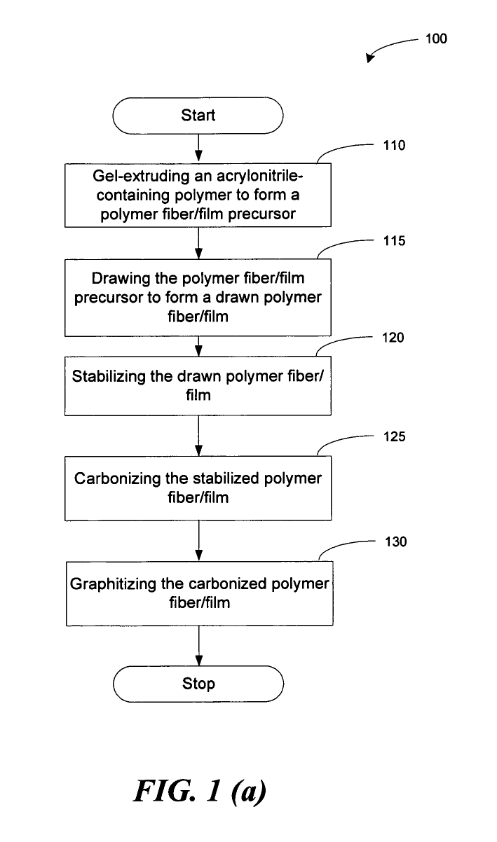

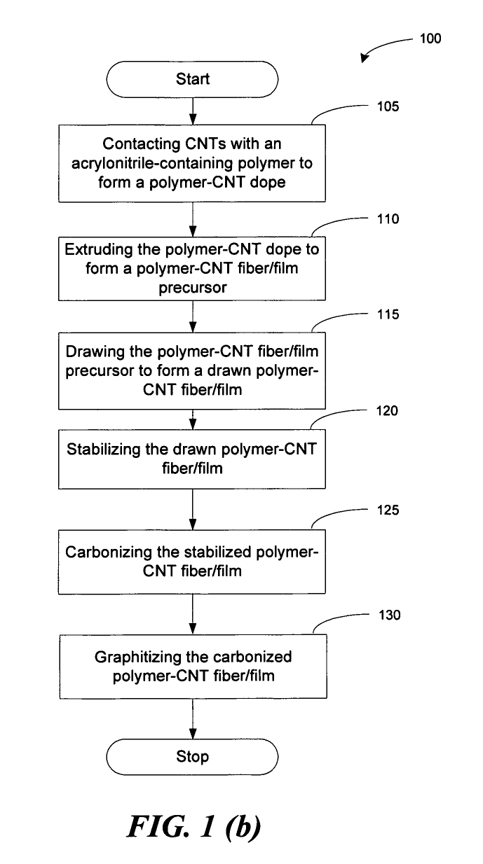

Referring now to FIGS. 1(a) and (b), processes, generically designated 100, for manufacturing such carbon fibers or films in accordance with some embodiments of the present invention are shown. Specifically, FIG. 1(a) illustrates a process for manufacturing carbon fibers or films from an acrylonitrile-containing polymer without including CNTs. The process 100 begins at 110, where the acrylonitrile-containing polymer is gel-extruded to form a polymer fiber precursor or a polymer film precursor, which is then drawn, at 115, to form a drawn polymer fiber or drawn polymer film, respectively. At 120, the drawn polymer fiber or drawn polymer film is thermally stabilized. At 125 and 130, the stabilized polymer fiber or stabilized polymer film is optionally carbonized and optionally graphitized, respectively, to form the final carbon fiber or film. In exemplary embodiments, one or more of the gel-extruding 110, drawing 115, stabilizing 120, carbonizing 125, and graphitizing 130 steps are continuous , rather than batch, processes.

FIG. 1(b) illustrates a process for manufacturing carbon fibers or films from a composite containing the acrylonitrile-containing polymer and CNTs and/or graphite sheets. While the process shown in FIG. 1 (b) makes reference to CNTs only, it is to be understood that graphite sheets can be implemented either in place of, or in addition to, the CNTs in the process. Thus, for example, when reference is made to stabilizing 120 a drawn polymer-CNT fiber or film, a drawn polymer-graphite sheet fiber or film, or a drawn polymer-CNT/graphite sheet fiber or film, can also be stabilized 120 under the process conditions shown in the figure and described below.

The process shown in FIG. 1(b) 100 begins at 105, where the CNTs (whether as-synthesized, purified, or derivitized) are contacted with the acrylonitrile-containing polymer to form a polymer-CNT dope. Next, at 110, the polymer-CNT dope is extruded to form a polymer-CNT fiber precursor or polymer-CNT film precursor, which is then drawn, at 115, to form a drawn polymer-CNT fiber or drawn polymer-CNT film, respectively. Similarly, at 120, the drawn polymer-CNT fiber or drawn polymer-CNT film is thermally stabilized. At 125 and 130, the stabilized polymer-CNT fiber or stabilized polymer-CNT film is optionally carbonized and graphitized, respectively, to form the final carbon fiber or film. Just as for the process shown in FIG. 1(a), in exemplary embodiments, one or more of the contacting 105, extruding 110, drawing 115, stabilizing 120, carbonizing 125, and graphitizing 130 steps are continuous process steps.

Hereinbelow, the various process steps will be described with reference to the process illustrated in FIG. 1(b). It will be understood, however, that with the exception of contacting step 105, the steps described below are equally applicable to the process shown in FIG. 1(a) (i.e., for making carbon fibers or films using an acrylonitrile-containing polymer without CNTs and/or graphite sheets) without departure from the details and parameters provided below. Thus, for example, when reference is made to stabilizing 120 a drawn polymer-CNT fiber or film, a drawn polymer (without CNTs and/or graphite sheets) fiber or film can also be stabilized 120 under the general conditions encompassed by the parameters described below. It will equally be understood that any reference to amounts, ratios, and the like of CNTs only refer to the process illustrated in FIG. 1 (b). For the sake of brevity (i.e., to minimize repetition of text wherein process steps, conditions, amounts, ratios, and the like are described relative to CNTs are again described for graphite sheets), it is to be understood that, by extension, all reference to CNTs is intended to include graphite sheets, whether used as a substitute for CNTs or in conjunction with CNTs.

To effect the contacting 105, the CNTs (and/or, by extension, the graphite sheets) can be first dispersed in a solvent, followed by addition of the acrylonitrile-containing polymer. Alternatively, the CNTs and the acrylonitrile-containing polymer can be mixed simultaneously (i.e., rather than stepwise) in the solvent. In another alternative, the acrylonitrile-containing polymer can be first dispersed in a solvent, followed by addition of the CNTs, which can be dry or dispersed in the same or a different solvent as well. In yet another alternative, the CNTs can be combined with the acrylonitrile-containing polymer in a melt. In still another alternative, dry CNTs or CNTs in solution can be added to the acrylonitrile-containing polymer while the acrylonitrile-containing polymer is at the monomer stage, or at any time during the polymerization that results in the acrylonitrile-containing polymer.

The solvent is desirably one that can solubilize both CNTs and acrylonitrile-containing polymers. Dimethyl formamide (DMF) and dimethyl acetamide (DMAc) are exemplary solvents that can be used to suspend or solubilize polyacrylonitrile polymers and copolymers. Other examples of organic solvents that can be used to suspend polyacrylonitrile polymers and copolymers include, but are not limited to, dimethylsulfoxide (DMSO), ethylene carbonate, dioxanone, chloroacetonitrile, dimethyl sulfone, propylene carbonate, malononitrile, succinonitrile, adiponitrile, .gamma.-butyrolactone, acetic anhydride, ε-caprolactam, bis(2-cyanoethyl)ether, bis(4-cyanobutyl)sulfone, chloroacetonitrile/water, chloroacetonitrile, cyanoacetic acid, dimethyl phosphate, tetramethylene sulfoxide, glutaronitrile, succinonitrile, N-formylhexamethyleneimine, 2-hydroxyethyl methyl sulfone, N-methyl-β-cyanoethylformamide, methylene dithiocyanate, N-methyl-α,α,α,-trifluoroacetamide, 1-methyl-2-pyridone, 3,4-nitrophenol, nitromethane/water (94:6), N-nitrosopiperidine, 2-oxazolidone, 1,3,3,5-tetracyanopentane, 1,1,1-trichloro-3-nitro-2-propane, and p-phenol-sulfonic acid. Examples of inorganic solvents include, but are not limited to, aqueous concentrated acids, such as concentrated nitric acid (approximately 69.5 wt % HNO₃), concentrated sulfuric acid (approximately 96 wt % H₂SO₄), and the like; and concentrated salt solutions, such as zinc chloride, lithium bromide, sodium thiocyanate, and the like.

Mixing techniques or means to disperse the nanotubes and/or the acrylonitrile-containing polymer in the solvent include, but are not limited to, sonication (e.g., with a bath sonicator or a probe sonicator), homogenation (e.g., with a bio-homogenizer), mechanical stirring (e.g., with a magnetic stirring bar), high shear mixing techniques, extrusion (e.g., single- or multiple-screw), and the like. In some embodiments, heat can be applied to facilitate dispersing the CNTs and/or the acrylonitrile-containing polymer in the solvent. Generally, heat can be applied up to the boiling point of the solvent.

The time of mixing is dependent on various parameters, including, but not limited to, the solvent, temperature of the mixture, concentration of the nanotubes and/or the acrylonitrile-containing polymer, and mixing technique. The mixing time is the time needed to prepare a generally homogeneous suspension or dispersion.

After dispersing the CNTs and/or acrylonitrile-containing polymer in the selected solvent to form a suspension, some of the solvent can optionally be removed. Solvent removal can be achieved by any known means, such as with the application of heat, application of a vacuum, ambient solvent evaporation, or the like. The time and temperature needed to adjust the concentration of the solvent in the suspension are dependent on various parameters, including, but not limited to, the particular solvent used, the amount of solvent to be removed, and the nature of the solvent.

The acrylonitrile-containing polymer concentration in the particular solvent is dependent on various factors, one of which is the molecular weight of the acrylonitrile-containing polymer. The concentration of the polymer solution is selected to provide a viscosity conducive to the selected fiber or film extruding technique. Generally, with respect to the preparation of a polymer solution, the polymer molecular weight and polymer concentration are inversely related. In other words, the higher the molecular weight of the polymer, the lower the concentration of polymer needed to obtain the desired viscosity. By way of example, solutions up to about 25 wt % could be made with an acrylonitrile-containing polymer, in DMF or DMAc, having a molecular weight on the order of about 50,000 g/mole; solutions up to about 15 wt % polymer could be made with an acrylonitrile-containing polymer having a molecular weight of about 250,000 g/mole; and solutions up to about 5 wt % could be made with an acrylonitrile-containing polymer having a molecular weight of about 1,000,000 g/mole. The solution concentrations would also depend on, among other variables, the particular polymer composition, the particular solvent, and solution temperature.

When the acrylonitrile-containing polymer is added to the nanotube-solvent suspension, it is homogenized to form an optically homogeneous polymer-CNT solution or suspension, also called a “dope”. The acrylonitrile-containing polymer can be added all at one time, gradually in a continuous fashion, or stepwise to make the generally homogeneous solution. Mixing of the polymer to make an optically-homogeneous solution can be done using any technique, such as mechanical stirring, sonication, homogenization, high shear mixing, extrusion, or combinations thereof.

Similarly, when the CNTs and the acrylonitrile-containing polymer are mixed with the solvent simultaneously, the three components are mixed to form an optically homogenous polymer-CNT dope. Mixing of the nanotubes and polymer to make an optically-homogeneous solution can be done using any technique, such as mechanical stirring, sonication, homogenization, high shear mixing, extrusion, or combinations thereof.

The nanotubes will generally comprise about 0.001 wt % to about 40 wt % of the dope, with about 0.01 wt % to about 5 wt % being preferable.

After preparation of the generally homogeneous polymer-CNT dope, the dope is extruded 110 into a polymer-CNT fiber or film. As used herein, the term “extruding” is intended to generically include not only extruding techniques used to make drawable films, but also spinning techniques used to make drawable fibers. The extruding step 110 can be effected using any means of making drawable fibers or films. Examples of techniques suitable for making drawable fibers or films include, but are not limited to, gel extruding (which includes gel spinning), wet extruding (which includes wet spinning), dry extruding (which includes dry spinning), dry-jet wet extruding (which includes dry jet wet spinning), electroextruding (which includes electrospinning), melt extruding (which includes melt spinning), and the like. When extruding a film, a slit shaped die is used. After the polymer is extruded through the spinneret or die, the fiber or film, respectively, is drawn 115 in a manner consistent with the particular extruding technique used.

In an exemplary embodiment, the technique used to extrude the dope is gel extrusion. The polymer concentration, solvent concentration, gelation media, and the gelation time can be varied to effect the desired properties of the drawn fibers or films as would readily be understood by those skilled in the art to which this disclosure pertains.

The drawn polymer-CNT precursor fiber can have an average diameter of about 100 nm to about 100 micrometers (μm), with about 200 nm to about 15 μm being preferred. Analogously, the drawn polymer-CNT film precursor can have an average thickness of about 50 nm to about 500 μm, with about 100 nm to about 100 μm being preferred. Within the drawn polymer-CNT fiber or film precursor, the CNTs can be tubular or they can be flattened or collapsed. In some embodiments, particularly with CNTs having an average diameter of less than or equal to about 15 nm, the flattened or collapsed CNTs can become unraveled or unwrapped so as to become a graphite sheet having a width of about 0.5 nm to about 100 nm.

After the drawing step 115, the drawn polymer-CNT fiber or film is thermally stabilized 120. Stabilization 120 generally comprises a heat treatment wherein the drawn polymer-CNT fiber or film can optionally be placed under stress or tension. The heat treatment occurs in an oxidizing atmosphere. During this oxidative stabilization 120, the acrylonitrile-containing polymer undergoes a chemical change that results in it having an increased density. It is believed that, in some embodiments, the stabilization process causes cyclization of the acrylonitrile-containing polymer, leading to what is termed a “ladder polymer.” In addition it is possible for some hydrogen evolution and/or oxygen absorption to occur.

Generally, the stabilization step 120 occurs at about 200° C. to about 400° C. in air, and can last for up to 36 hours, with about 30 seconds to about 24 hours being preferred. The exact temperature and duration depends, in part, on the acrylonitrile-containing polymer composition and the drawn polymer-CNT fiber diameter or film thickness. In some embodiments, the heat treatment can be a multi-step heat treatment.

Next, the stabilized fibers or films are carbonized 125. Carbonization 125 generally comprises a heat treatment in an inert environment (e.g., nitrogen, helium, argon, and the like) at a more elevated temperature than the stabilization temperature. This step can be performed with the stabilized fibers or films under tension or stress. During carbonization 125, the carbon content of the stabilized fibers or films is increased (e.g., to above 90 wt %), and a three-dimensional carbon structure can form. This generally occurs via pyrolysis.

Generally, the carbonization step 125 occurs at about 500° C. to about 1800° C. Further, the duration can be up to about 2 hours, with about 1 millisecond to about 60 minutes being preferred. The exact temperature and duration can, in part, depend on the acrylonitrile-containing polymer composition and the concentration of CNTs present in the composite. For example, using higher carbonization temperatures can result in an increased modulus. In some embodiments, the heat treatment can be a multi-step heat treatment.

After carbonization 125, the fibers or films can undergo an optional graphitization step 130. Graphitization 130 generally comprises a heat treatment in an inert environment at a more elevated temperature than the carbonization temperature. Nitrogen is not used in the graphitization step 130 because it can react with carbon to form a nitride. This step can be performed with the carbonized fibers or films under tension or stress.

Generally, the graphitization step 130 occurs at about 1800° C. to about 2800° C. The duration can be up to about 1 hour, with about 1 millisecond to about 15 minutes being preferred. The exact temperature and duration also depends, in part, on the acrylonitrile-containing polymer composition and the concentration of CNTs present in the composite. In some embodiments, the heat treatment can be a multi-step heat treatment.

Reference will now be made to the resultant carbon fibers and films containing CNTs and/or graphite sheets. As mentioned above, it is to be understood, for the sake of brevity and minimizing repetition of text, by extension, that all reference to CNTs is intended to include graphite sheets, whether used as a substitute for CNTs or in conjunction with CNTs. In some situations, for the sake of clarity, reference will be made to the analogous condition/property for graphite sheets in a first description, but will not be repeated throughout the rest of the text.

The final carbon fibers generally have an average cross-sectional dimension (i.e., diameter) of about 50 nm to about 50 μm, with about 100 nm to about 10 μm being preferred. The final carbon films generally have an average cross-sectional dimension (i.e., thickness) of about 25 nm to about 250 μm, with about 50 nm to about 150 μm being preferred; and there is no particular limit on the width of the films. Depending on the particular dimensions of the fibers or films, the films or fibers can be optically transparent. The CNTs are present in the final polymer-CNT fiber or film in a range of about 0.001 wt % to about 80 wt %, with about 0.01 wt % to about 5 wt % being preferable.

In exemplary embodiments, the CNTs in the final carbon fibers or films are exfoliated. That is, the CNTs are generally not found in large bundles or ropes of CNTs; and the graphite sheets are generally not found as overlapping stacks of sheets. More specifically, in these embodiments, the CNTs (and/or graphite sheets) in the final carbon fibers or films exist as individual nanotubes (and/or sheets) or as groups (and/or stacks) averaging less than 10 nanotubes (and/or sheets) per group. In some embodiments, the groups average less than 5 nanotubes. In other embodiments, groups averaging less than 3 nanotubes have been observed. Without being bound by theory, exfoliation of the nanotubes is believed to be effected in different ways. It has been found that increased concentrations of nanotubes results in greater bundling in the final carbon fibers or films. Thus, exfoliation of the CNTs can be achieved using lower concentrations of nanotubes. In addition, regular or continuous drawing during the drawing step 115 is believed to produce better exfoliation of the CNTs. By way of example, mixing a dilute dispersion (e.g., 10 milligrams of small diameter CNTs in 300 milliliters of solvent) with the acrylonitrile-containing polymer during the contacting step 105, followed by regular drawing during drawing step 115 can produce carbon fibers having CNTs existing either individually or in groups averaging less than 3 nanotubes.

In an advantageous feature of the processes disclosed herein, the graphitization step 130 is not necessary. In fact, even without a graphitization step, the presence of the CNTs in the acrylonitrile-containing polymer induces graphitization at the low temperatures of the carbonization step 125. Specifically, after carbonization, a crystallized graphitic region extending radially about 0.34 nanometer (nm) to about 50 nm from the wall of each CNT can be observed. With respect to the graphite sheets, the crystallized graphitic region can extend directly about 0.34 nanometer (nm) to about 50 nm from the surface of each sheet. More commonly, the crystallized graphitic region extends radially (and/or directly) about 1 nm to about 30 nm from the wall (and/or surface) of each CNT (and/or graphite sheet). Even more specifically, the crystallized graphitic region extends radially at least about 2 nm from the wall of each CNT. Stated another way, the presence of 1 wt % CNTs in the polymer-nanotube mixture affected the reactivity of up to about 30% of the polymer in the vicinity of the CNTs. These results are quite surprising considering the low temperature of the carbonization step 125 of the processes of the present invention.

Further, the application of tension to the fibers or films during one or more of the stabilization, carbonization, and optional graphitization steps is also believed to contribute to the crystallization of the graphitic regions surrounding the CNTs. Thus, in exemplary embodiments, tension is applied to the fibers or films during each of these steps.

In another advantageous feature of the processes disclosed herein, stabilizing and carbonizing (and optionally graphitizing) the drawn fibers or films produces carbon fibers or films having an increased tensile modulus and strength. Generally, at least an 0.5 gigaPascals (GPa) increase in tensile strength and at least a 50 GPa increase in tensile modulus can be achieved with the addition of about 1 wt % CNTs in the polymer-nanotube mixture, relative to a carbon fiber or film prepared using the same procedure but without any CNTs. For fibers or films, improvements of up to 3 GPa or more in tensile strength and up to 200 GPa or more in tensile modulus can be achieved with the addition of about 1 wt % CNTs in the polymer-nanotube mixture (again, relative to a carbon fiber or film prepared using the same procedure but without any CNTs). In one fiber example, an 0.7 GPa (0.4 N/tex) increase in tensile strength and a 77 GPa (43 N/tex) increase in tensile modulus were attained for polyacrylonitrile-based carbon fibers having about 1 wt % CNTs and having an average fiber diameter of about 13 μm. In another fiber example, a 1.2 GPa (0.7 N/tex) increase in tensile strength and a 148 GPa (82 N/tex) increase in tensile modulus were attained for polyacrylonitrile-based carbon fibers having about 1 wt % CNTs and having an average fiber diameter of about 6 μm.

The final carbon fibers or films can have tensile strengths of up to about 10 GPa or more, and tensile moduli of up to about 750 GPa or more. For example, carbonized carbon fibers produced from PAN and CNTs by gel extrusion can exhibit a tensile strength of about 6 GPa and a tensile modulus of about 600 GPa without undergoing a graphitization step. Further, it is also possible to obtain carbon fibers or films having higher compressive strengths than tensile strengths.

Another improvement that is observed with the carbon fibers or films of the present invention includes improved electrical conductivity. The electrical conductivity of a carbon fiber or film prepared using the processes described herein, can increase at least about 25 percent relative to that of a carbon fiber or film without CNTs. In one example, conductivities increased by more than 50 percent. Further, in some embodiments, conductivities of more than two, five, or even ten, times that of a carbon fiber or film without CNTs can be achieved.

The various embodiments of the present invention are further illustrated by the following non-limiting examples.

### EXAMPLES

### Example 1

### Exfoliated and Oriented CNTs in Gel Spun PAN/CNT Composite Fibers

In this example, gel spun PAN/CNT fibers having various levels of CNTs were prepared and characterized.

A poly(acrylonitrile-co-methylacrylate) copolymer of PAN having a viscosity average molecular weight of 2.5×10⁵ g/mol was obtained from Japan Exlan Company, Ltd. The PAN copolymer contained about 6.7 mol % methylacrylate, as characterized using ¹H NMR. A mixture of single and double wall carbon nanotubes, having an average diameter of about 2 nm, were obtained from Carbon Nanotechnologies, Inc. (Houston, Tex.). Based on thermogravimetric analysis (TGA) in air, the CNTs used in this study contained less than 1 wt % metallic impurity. Bright field transmission electron microscopy revealed CNT bundle diameters as large as 100 nm. Dimethyl formamide (DMF) from Sigma-Aldrich, Co. was used as received.

CNTs were dispersed in DMF at a concentration of 40 mg/L using 24 h bath sonication (Branson 3510R-MT, 100 W, 42 kHz) at room temperature. PAN (15 g) was dried in vacuum at 100° C. and dissolved in DMF (100 mL) at 80° C. An optically homogeneous CNT/DMF dispersion was added to the PAN/DMF solution. The excess amount of solvent was evaporated by vacuum distillation at 80° C., while stirring, to obtain the desired solution concentration (15 g solids (PANC+CNT)/100 mL solvent). Similarly, other solutions were prepared to yield CNT concentration with respect to the polymer of 0, 0.5, and 1 wt %. The PAN/DMF and PAN/CNT/DMF solutions were spun at 31.4 m/min using a 500 μm diameter single hole spinneret at 110° C. into a methanol bath maintained at −50° C. The air gap between spinneret and the methanol bath was about 2 cm. The as-spun fibers were taken up at 100 m/min and were kept immersed in methanol bath (maintained between −20 and −40° C.) for 1 week, to ensure gelation. As a result, the as spun fiber draw ratio was 3.2. The gel fiber was further drawn (draw ratio in the range of 7-16) at 160° C. in glycerol bath followed by washing in ethanol and vacuum drying at 40° C. for 3 days. The total draw ratio, determined by multiplying spin draw ratio with post draw ratio, was as high as 51.

Optical microscopy was carried out using a Leitz polarizing microscope. UV-vis spectra on solution and various fibers were obtained using SEE 1100 microspectrometer. Single filament tensile properties were determined using RSA III solids analyzer (Rheometric Scientific, Co.) at a gauge length of 25 mm and the crosshead speed of 0.25 mm/s. For each sample, 15 filaments were tested. Dynamic mechanical tests were also conducted using RSA III at 0.1, 1, and 10 Hz at a heating rate of 1° C./min on a bundle of 10 filaments, also using a gauge length of 25 mm. Raman spectra were collected in the back scattering geometry using Holoprobe Research 785 Raman Microscope made by Kaiser Optical System using 785 nm excitation laser with polarizer and analyzer parallel to each other (vv mode). Spectra were obtained with the fiber axis at 0, 5, 10, 20, 30, 40, 50, 60, 70, 80, 85, and 90° from the polarization direction. The CNT orientation in the composite fiber was determined from the peak intensity of the tangential band (ca. 1590 cm⁻¹) at various polarization angles. WAXD patterns were obtained on multifilament bundles on Rigaku Micromax-007 (λ=1.5418 Å) using Rigaku R-axis IV++ detection system. The diffraction patterns were analyzed using AreaMax V. 1.00 and MDI Jade 6.1. From the azimuthal scans of the diffraction peak at 2θ˜17°, PAN molecular orientation was determined. The crystallinity was determined using the integrated scans and the areas of the deconvoluted peaks. For baseline subtraction, linear line was drawn between 2θ=10 and 50°. The PAN crystal size was also determined from the equatorial peak at 2θ˜17° using Scherrer equation (κ=0.9). Fiber tensile fracture surfaces were observed on the gold coated samples by scanning electron microscopy (LEO 1530 SEM operated at 18 kV). Transmission electron microscopy study was conducted using Hitachi HF-2000 (operated at 200 kV). For TEM specimen preparation, the PAN/CNT composite fiber (draw ratio 51) containing 1 wt % CNT was heated in DMF at 150° C. for 30 min. The disintegrated fibrils were collected on lacey carbon TEM grids. TEM beam alignment and stigmation corrections were performed using evaporated aluminum standard (cat#80044, EMS, Co.).

WAXD photographs, as well as integrated and equatorial 2θ scans for PAN and PAN/CNT (1 wt %) fibers were obtained. Various structural parameters were determined from the X-ray study for the control PAN fiber at several draw ratios and for the fully drawn composite fibers. The equatorial peaks at 2θ˜17 and 30° shift to higher angles with increasing draw ratio, resulting in closer packing as the transverse dimension of the PAN molecules decreases with stretching. The equatorial d-spacing of the fully drawn fiber further decreased with the incorporation of CNT. The ratio of these two equatorial d-spacings for the as-spun PAN sample (1.705) is significantly less than the value for hexagonal packing, which is the square root of 3 or 1.732. On drawing, this ratio approaches the hexagonal packing value of 1.732, both in the control PAN as well as in PAN/CNT composite. The decrease in d-spacing for the control gel spun PAN as a function of draw ratio was as expected.

With increasing draw ratio, planar zigzag sequences are likely to increase while the helical sequences in the crystal will be decreased. This conformational difference was observed from the meridional peak. Generally a PAN meridional peak can be deconvoluted into two peaks at 2θ=36 and 40° resulting from the planar zigzag and helical sequences, respectively. The control PAN and the PAN/CNT composite in this study did not reveal two peaks. However, the peak position was shifted to a lower angle with an increasing draw ratio as well as with the incorporation of CNT, suggesting a tendency for increasing planar zigzag sequences. Crystallinity, orientation, and crystal size increased with increasing draw ratio. Composite fibers exhibited slightly higher crystallinity, polymer orientation, and somewhat lower crystal size when compared to the control fiber of the same draw ratio (draw ratio 51). Scanning electron micrographs of the tensile fractured fiber surfaces show that both the control and composite fibers exhibit fibrillar structure. Bright field high resolution transmission electron micrographs of PAN/CNT (1 wt %) fibers show aligned and exfoliated CNTs. A PAN crystal lattice (0.52 nm spacing) can also be observed in the CNT vicinity.

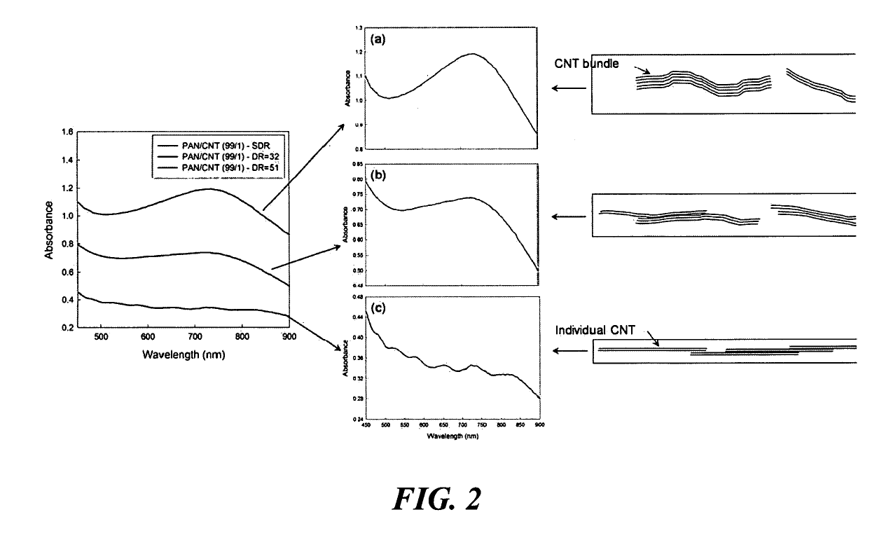

Exfoliated SWNTs exhibit van Hove transitions, while these transitions are suppressed in CNT bundles. The dilute PAN/CNT/DMF solution before DMF evaporation showed van Hove transitions, suggesting CNT exfoliation in solution. However, the as spun gel fiber did not exhibit van Hove transitions, suggesting CNT re-aggregation during processing. The composite fiber with the intermediate draw ratio of 32 also did not exhibit these transitions. However, the fully drawn composite fiber (draw ratio 51) exhibited van Hove transitions, suggesting that CNT exfoliation occurred during drawing. The schematic of the CNT exfoliation process is also shown in FIG. 2.

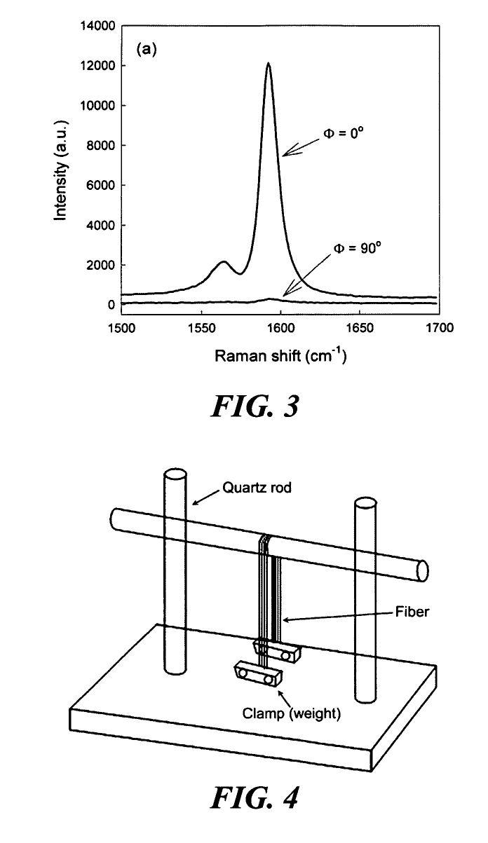

The G-band intensity ratio, with polarization parallel and perpendicular to the fiber axis, at about 1592 cm⁻¹ is taken as a measure of CNT orientation in the composite and in CNT fibers. The G-band Raman spectra when the angle between polarizer and fiber axis are 0 and 90° is shown in FIG. 3 and, from it, the Raman G-band ratio for the PAN/CNTs composite fiber (1 wt % CNT, draw ratio 51) was determined to be 42 for this particular sample. That is not to say that higher ratios cannot be achieved.

Fiber tensile properties were also obtained. With the addition of 1 wt % CNT, room temperature modulus increased by 6.6 GPa (from 22.1 GPa for PAN to 28.7 GPa for PAN/CNT). Assuming that the PAN modulus in the composite fiber is the same as in the control gel spun PAN, the modulus of the PAN/CNT composite with fully exfoliated CNT with an orientation factor of 0.915 was plotted. The composite fiber modulus calculated assuming ideal CNT orientation, and the observed moduli values were also plotted. Observed composite fiber modulus was the same as predicted assuming ideal CNT orientation. However, when the observed CNT orientation is taken into consideration, then one can see that experimental modulus is higher than the predicted value. This suggests a change in the PAN matrix modulus with the incorporation of CNTs. This is consistent with the slightly higher PAN crystallinity and orientation in the composite fiber.

### Example 2

### Stabilized and Carbonized Gel Spun PAN and PAN/CNT Composite Fibers

In this example, stabilized and carbonized gel spun PAN/CNT fibers having various levels of a mixture of single and double wall carbon nanotubes with 2 nm average diameters were prepared and characterized. The PAN and PAN/CNT composite fibers were processed by gel spinning as described above in EXAMPLE 1.

For stabilization, the gel-spun fibers were clamped between two carbon steel blocks and hung over a quartz rod, as shown in FIG. 4. Stabilization was carried out in a box furnace (Lindberg, 51668-HR Box Furnace 1200C, Blue M Electric) in air at various stress levels (0.025, 0.017, 0.009 and 0.006 N/tex, with stress being based on the linear density of the precursor fiber). The fibers were heated from room temperature to 285° C. in air at a heating rate of 1° C./min and held at 285° C. for 10 hr followed by heating up to 330° C. at a heating rate of 1° C./min and held at 330° C. for 3 hr. The stabilized fibers were cooled down to room temperature over a period of several hours. The stabilized PAN and PAN/CNT fibers were subsequently carbonized in argon by heating from room temperature at a rate of 5° C./min, and by holding at 1100° C. for 5 minutes at various stress levels (0.025, 0.017, 0.009 and 0.006 N/tex). In the initial study, the precursor fiber diameter was about 20 to about 23 μm, resulting in about 12 to about 13 μm diameter carbon fibers (also referred to as large diameter fibers). Since higher tensile strength can be obtained in smaller diameter fibers, PAN and PAN/CNT (99/1) fibers were also gel spun with a diameter of about 12 μm. These fibers resulted in about 6 μm diameter carbon fibers (also referred to as small diameter fibers).

The tensile properties and structural parameters of gel spun PAN and PAN/CNT (99/1) fibers are listed in TABLE 1. As can be seen, PAN/CNT precursor fibers exhibit moderately higher crystal orientation and crystallinity and smaller crystal size than the control PAN fiber. CNT orientation (f_{CNT}) in composite fiber was determined to be 0.904 using the Raman G-band.

TABLE 1
Properties and structural parameters of large diameter precursor gel
spun PAN and PAN/CNT (99/1) fibers used for carbon fiber processing.

| | |
|---|---|
| PAN | PAN/CNT (99/1) |

| | |
|---|---|
| Draw ratio | 38 |

| | | |
|---|---|---|
| Linear density (tex) | 0.52 | 0.44 |
| Tensile modulus (N/tex) | 17.8 ± 1.9 | 22.5 ± 1.9 |
| Tensile strength (N/tex) | 0.72 ± 0.12 | 0.89 ± 0.08 |
| Strain to failure (%) | 7.9 ± 1.2 | 8.2 ± 0.6 |
| Crystallinity (%) | 65 | 68 |
| Crystallite size (nm) | 11.3 | 10.8 |
| f_{c} | 0.916 | 0.927 |
| F_{CNT} | — | 0.904 |

DSC thermograms of PAN and PAN/CNT fibers under air reveal that the heat evolved in the composite fibers during stabilization is less than that in the control fiber. This suggests that the presence of CNT hinders PAN stabilization reaction. As a result, a relatively long stabilization time was implemented. CNTs have good interaction with PAN. As a result, PAN in the vicinity of CNT becomes insoluble in DMF. The DSC study suggests that, as a result of PAN-CNT interaction, PAN in the vicinity of CNT has higher thermal stability than PAN without CNT. This explains the reduced heat of stabilization for PAN/CNT fiber as compared to the control PAN. PAN shows no heat evolution during the third heating cycle, while PAN/CNT (99/1) fibers still shows about 30 J/g of heat of stabilization reaction. This suggests that stabilization in PAN/CNT is still continuing, while stabilization in PAN was not observable (by DSC) during the third heating cycle.

Infrared spectra of fibers stabilized with and without stress were obtained. Stabilization without stress was carried out in air in a thermogravimetric analyzer (TGA) for 30 min. The chemical structures of various nitrile groups are shown below.

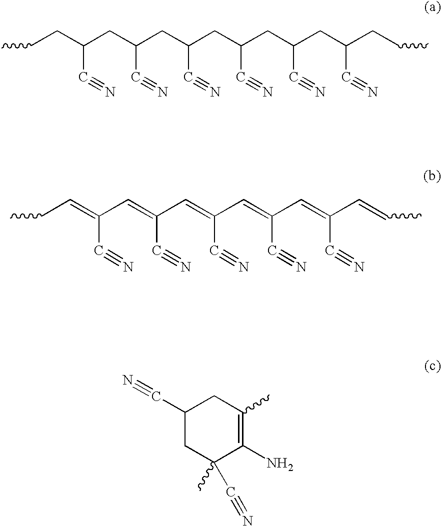

The conjugated nitrile group (b) can be generated upon dehydrogenation of PAN and β-amino nitrile groups (c) can be formed due to the termination of cyclization reaction. The termination of cyclization is thought to take place every 4-5 PAN repeat units, a result of its helical conformation. Therefore, more planar zigzag conformation in the fiber is expected to increase the gap between cyclization termination. Chain scission may occur during cyclization termination. Therefore, without being bound by theory, it is believed that the fiber containing more planar zigzag conformations would result in less frequent chain scission, and hence result in less defects, thus ultimately affecting the tensile strength of the resulting carbon fiber. The PAN/CNT gel fiber has more planar zigzag sequences than the PAN fiber. This difference may affect stabilization. Since the peak positions of different types of nitrile groups are known, the nitrile spectra were fitted without varying the peak positions, and by allowing the peak width and intensity to vary. There were more unreacted nitrile groups (a) in PAN/CNT stabilized under stress than in the control PAN stabilized under the same conditions, and the quantity of unreacted groups increased with increasing stress as judged by the relative areas of the FTIR peaks. Thus, it would appear that the presence of CNT as well as stress hinders stabilization reaction. PAN/CNT samples stabilized in a furnace under stress exhibited significantly higher conjugated nitrile and significantly lower β-amino nitrile than the control PAN stabilized under the same conditions. The stabilized structure in PAN/CNT predominantly contains conjugated nitrile, while in PAN it is predominantly β-amino nitrile. This further appears to suggest that CNTs constrains PAN molecules and hence results in the higher degree of cyclization as discussed earlier.

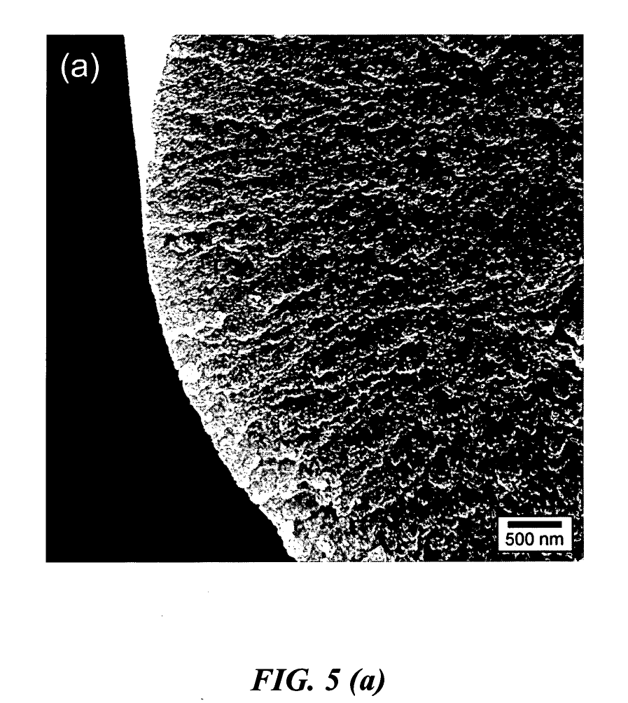

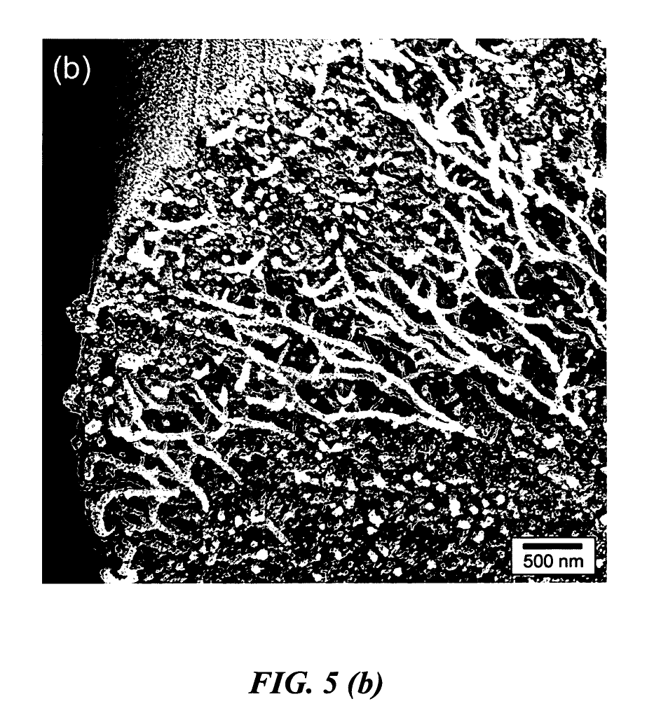

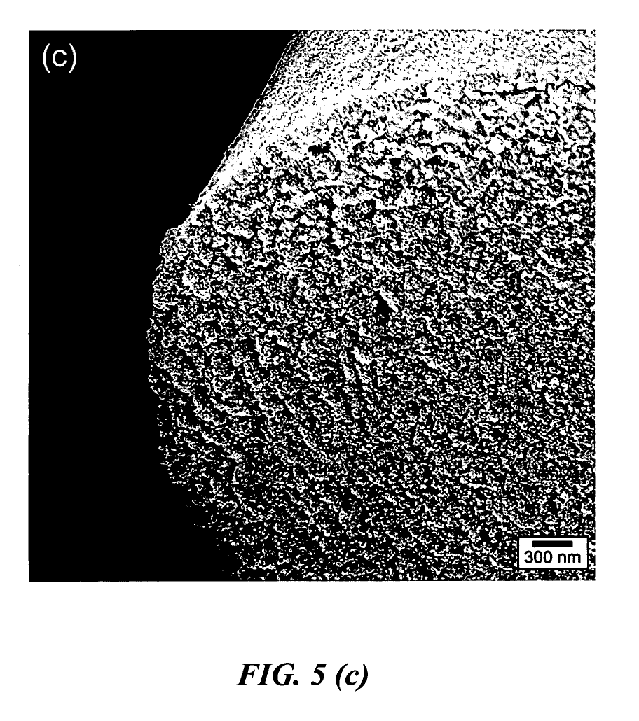

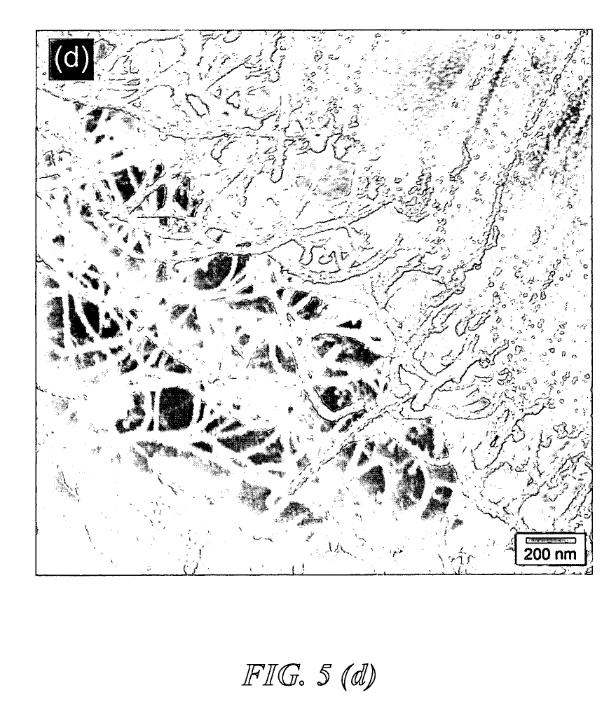

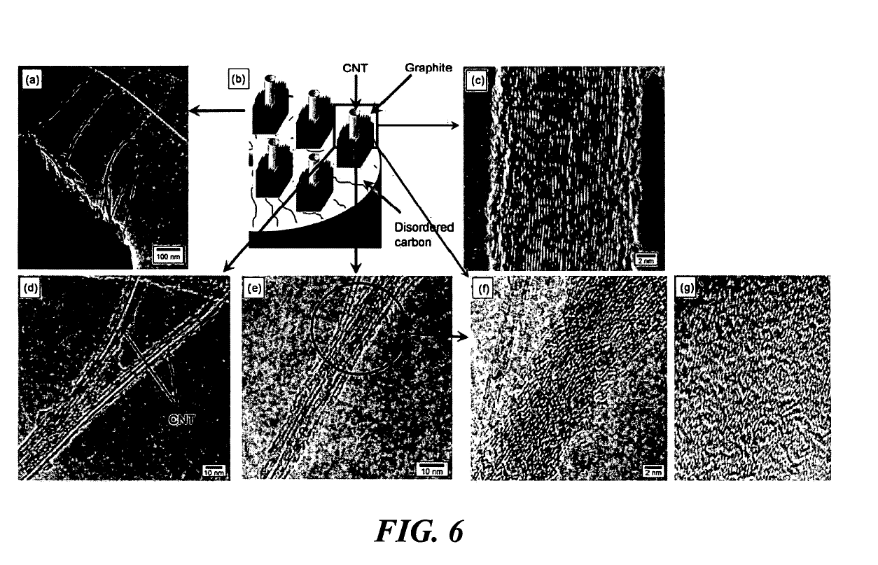

PAN molecules in the interphase region have higher orientation than in the matrix. As shown in FIG. 5, PAN/CNT composite fibers exhibit a fibrillar structure even after stabilization and carbonization. The carbonized composite fiber contains nanofibrils embedded in the brittle carbon matrix. It is believed that the nanofibrils include CNTs surrounded by a well developed graphitic structure. PAN molecules in the interphase region when carbonized form well ordered graphite, while PAN matrix at this carbonization temperature is mostly disordered or amorphous carbon. This effect is illustrated in FIG. 6.

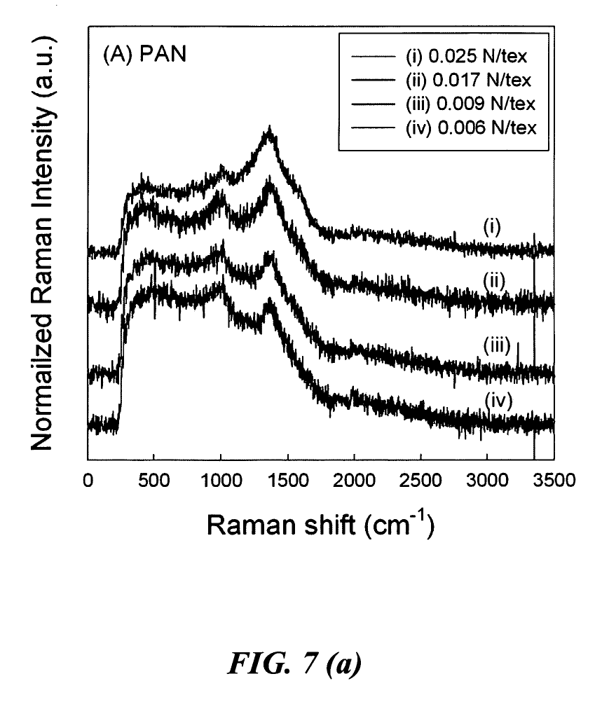

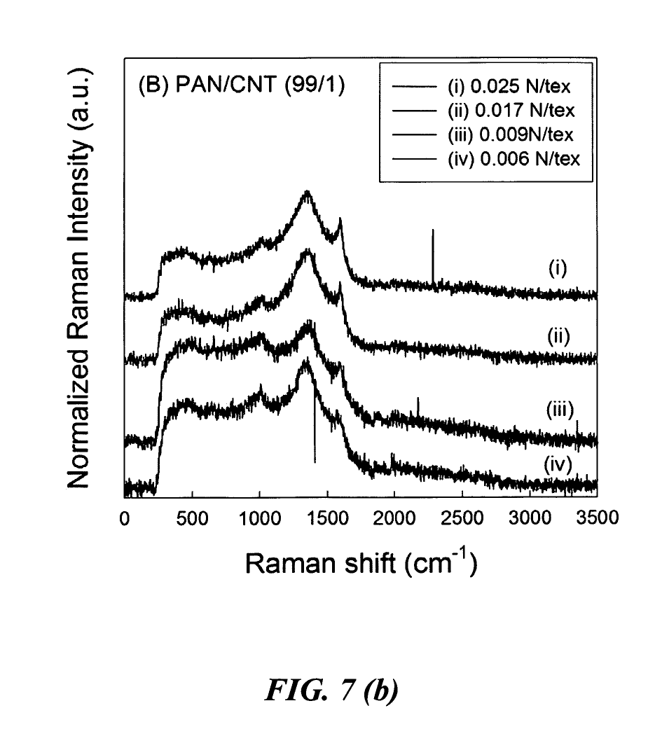

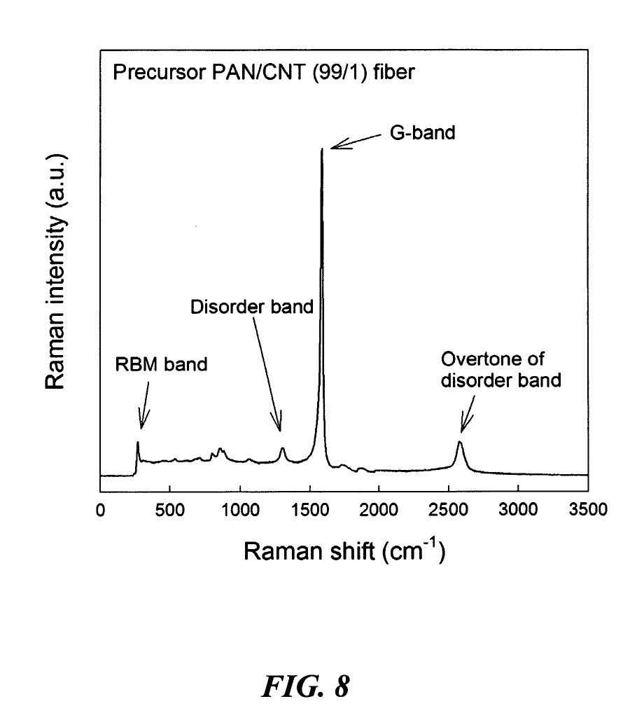

The Raman spectra of carbonized PAN fibers, shown in FIG. 7(a), exhibit a strong disorder band (˜1300 cm⁻¹) and begins to show a shoulder for the graphitic G-band (˜1580 cm⁻¹) when stress is increased during stabilization and carbonization. On the other hand, carbonized PAN/CNT fibers exhibit a distinct G band, as illustrated in the Raman spectra of FIG. 7(b), even when stabilized and carbonized at low stress. The G band intensity increases with increasing stress, confirming stress induced graphitization. The Raman observation is in agreement with high resolution transmission electron microscopy, showing less ordered carbon for carbonized PAN and well ordered carbon for carbonized PAN/CNT. It should also be noted that the G band in carbonized PAN/CNT fibers is not due to CNTs. Owing to resonance, CNTs result in a very strong intensity G band, as shown in FIG. 8. In the stabilized and carbonized fiber, laser is absorbed by the stabilized and carbonized products of PAN, quenching CNT spectra.

PAN-based fibers typically result in disordered carbon after carbonization. In order to develop a graphitic structure, PAN based fibers are typically heat treated at more elevated temperatures than a typical carbonization step. For example, in order to develop a graphitic structure, PAN based fibers can be heated treated at about 2500 to about 3000° C. Development of a graphitic structure (as evidenced by Raman G band and high resolution transmission electron microscopy) in PAN/CNT at a relatively low carbonization temperature of 1100° C. suggests that the presence of CNT not only affects PAN stabilization, but also leads to more graphitic structure at a relatively low carbonization temperature.

WAXD patterns and integrated scans were obtained for the precursor, stabilized, and carbonized fibers. Higher orientation and larger crystal size were observed for the stabilized and carbonized PAN/CNT fibers than that for the respective control fibers. Orientation and crystal size also increased with increasing applied stress during stabilization and carbonization.

As indicated by the data of TABLE 2, the tensile modulus of the stabilized PAN/CNT fibers is about 26% higher than the stabilized PAN fibers while the tensile strength and strain to failure of the two fibers were quite comparable. Increased stress during stabilization resulted in higher modulus and tensile strength. Fiber shrinkage decreases with increasing applied stress during stabilization. Also at a given stress, less shrinkage is observed in PAN/CNT than in PAN. The shrinkage data is based on the fiber length measurement before and after stabilization.

TABLE 2
Mechanical properties of stabilized large diameter PAN and PAN/CNT
fibers

| | Applied | Linear | Tensile | Tensile | Strain to |
|---|---|---|---|---|---|
| | stress | density | modulus | strength | failure |
| Precursor | (N/tex) | (tex) | (N/tex) | (N/tex) | (%) |
| Large diameter | 0.025 | 0.58 | 12.7 ± 1.3 | 0.26 ± 0.05 | 4.7 ± 0.5 |
| PAN | 0.006 | 0.77 | 8.7 ± 0.7 | 0.19 ± 0.03 | 5.2 ± 0.3 |
| Large diameter | 0.025 | 0.41 | 16.0 ± 0.7 | 0.29 ± 0.02 | 4.5 ± 0.6 |
| PAN/CNT | 0.006 | 0.64 | 11.3 ± 1.3 | 0.22 ± 0.03 | 4.6 ± 0.9 |
| (99/1) | | | | | |

As indicated by the data of TABLE 3, carbonized PAN/CNT fibers exhibit higher tensile strength and modulus than the control PAN fiber processed under the same conditions. The addition of 1 wt % CNT resulted in a 64% increase in tensile strength and a 49% increase in modulus for the small diameter carbon fiber. The substantially higher modulus in carbonized PAN/CNT as compared to carbonized PAN is attributed to higher orientation and higher graphitic order. For comparison, the tensile properties of the commercial carbon fibers are also listed in TABLE 3. As can be seen, the tensile modulus of the carbonized small diameter PAN/CNT (99/1) fibers is higher than the PAN based T300 and IM8 fibers. Tensile strength and modulus of the experimental PAN/CNT fibers can be further improved by process optimization.

TABLE 3
Mechanical properties of carbonized PAN and PAN/CNT fibers

| | Applied | Linear | Tensile | Tensile | |
|---|---|---|---|---|---|
| | stress | density | modulus | strength | Strain to |
| Precursor | (N/tex) | (tex)* | (N/tex)** | (N/tex)** | failure (%) |
| Large | 0.025 | 0.27 | 147 ± 13 | 1.1 ± 0.1 | 0.63 ± 0.08 |
| diameter | | | | | |
| PAN | | | | | |
| Large | | 0.25 | 184 ± 8 | 1.2 ± 0.1 | 0.65 ± 0.02 |
| diameter | | | | | |
| PAN/CNT | | | | | |
| (99.5/0.5) | | | | | |
| Large | | 0.22 | 190 ± 9 | 1.4 ± 0.1 | 0.75 ± 0.04 |
| diameter | | | | | |
| PAN/CNT | | | | | |
| (99/1) | | | | | |
| Small | | 0.064 | 168 ± 18 | 1.1 ± 0.2 | 0.68 ± 0.04 |
| diameter | | | | | |
| PAN | | | | | |
| Small | | 0.044 | 250 ± 27 | 1.8 ± 0.2 | 0.72 ± 0.05 |
| diameter | | | | | |
| PAN/CNT | | | | | |
| (99/1) | | | | | |
| Commercial | P-25 | 0.179*** | 84 | 0.7 | 0.9 |
| carbon | T-300 | 0.067*** | 129 | 1.8 | 1.5 |
| fibers [4] | IM8 | 0.037*** | 172 | 2.9 | 1.9 |

*tex is the mass in grams of 1000 m length of fiber.
**N/tex is same as GPa divided by density in g/cm³.
***Linear density of the commercial carbon fibers was calculated based on the diameter and density data reported by the manufacturer.

In this example, gel spun PAN and PAN/CNT composite fibers were stabilized and carbonized with varying stress. DSC showed significantly lower heat evolution in PAN/CNT fibers under oxidative stabilization than in PAN, suggesting that the presence of CNT hinders PAN reactivity. Infrared spectroscopy showed that even after prolonged stabilization under stress, PAN/CNT fiber contained more un-reacted nitrile than comparably stabilized PAN. The structure in stabilized PAN/CNT appeared to be predominantly composed of conjugated nitrile, while in stabilized PAN it appeared to be composed of predominantly (3-amino nitrile. A fibrillar structure was observed in the stabilized and carbonized PAN/CNT, while the corresponding PAN fibers exhibited brittle fracture. Carbonized PAN in the immediate vicinity of CNT is ductile while PAN carbonized farther away from carbon nanotubes or without carbon nanotubes is brittle. Carbonized PAN/CNT fibers exhibit slightly higher orientation, smaller graphite d-spacing and larger crystal size than PAN carbonized under similar conditions. PAN/CNT carbonized at 1100° C. under stress shows the development of graphitic structure (as evidenced by Raman and high resolution transmission electron microscopy), while carbonized PAN showed only the presence of disordered carbon. Small diameter carbonized PAN/CNT fibers containing 1 wt % CNT exhibited 64% higher tensile strength and 49% higher tensile modulus than the corresponding carbonized PAN.

### Example 3

### Carbon Fiber Preparation from Gel Spun PAN/MWNT (99/1) Fibers

In this example, gel spun PAN/multi-wall carbon nanotubes (MWNTs) fibers having 1 wt % MWNTs were prepared and characterized. The MWNTs had an average diameter of about 20 nm. The PAN and PAN/NT composite fibers were processed by gel spinning similar to what was described above in EXAMPLE 1, with the exception of using MWNTs. Slight variations in spinning rate, draw ratio, and the like were permitted.

The precursor fibers were stabilized under air using a two step heating profile consisting of ramping up the temperature to about 285° C. from room temperature over 260 minutes and heating at about 285° C. for about 4 hours, followed by a second ramping to about 330° C. over about 45 minutes and then heating at 330° C. for about 2 hours. The stabilized fibers were carbonized under argon at about 1200° C. for about 5 minutes. Based on the precursor fiber diameter, which was about 10 μm to about 12 μm, the stress applied to the fiber during the stabilization and carbonization steps was about 0.006 N/tex.

The mechanical properties of the resulting carbon fibers were measured. The linear density of the PAN/MWNT (99/1)-based carbon fiber was about 0.044 tex. The tensile strength and tensile modulus were about 1.67 N/tex and about 201 N/tex, respectively. Finally, the strain to failure was measured to be about 0.85%.

The embodiments of the present invention are not limited to the particular formulations, process steps, and materials disclosed herein as such formulations, process steps, and materials may vary somewhat. Moreover, the terminology employed herein is used for the purpose of describing exemplary embodiments only and the terminology is not intended to be limiting since the scope of the various embodiments of the present invention will be limited only by the appended claims and equivalents thereof. For example, temperature, stress, and time parameters may vary depending on the particular materials used.

Therefore, while embodiments of this disclosure have been described in detail with particular reference to exemplary embodiments, those skilled in the art will understand that variations and modifications can be effected within the scope of the disclosure as defined in the appended claims. Accordingly, the scope of the various embodiments of the present invention should not be limited to the above discussed embodiments, and should only be defined by the following claims and all equivalents.

1.-15. (canceled)

16. A method of making a carbon fiber or film, the method comprising:
contacting carbon nanotubes (CNT) with an acrylonitrile-containing polymer to form a polymer-CNT dope;
gel-extruding the polymer-CNT dope to form a polymer-CNT fiber or film precursor;
drawing the polymer-CNT fiber or film precursor to form a drawn polymer-CNT fiber or film; and
stabilizing the drawn polymer-CNT fiber or film.

17. The method of claim 16, further comprising carbonizing the stabilized polymer-CNT fiber or film.

18. The method of claim 17, further comprising graphitizing the carbonized polymer-CNT fiber or film.

19.-25. (canceled)

26. The method of claim 16, wherein the stabilizing comprises stabilizing the drawn polymer-CNT fiber or film in an oxidizing environment and/or wherein the stabilizing comprises stabilizing the drawn polymer-CNT fiber or film at about 200 degrees Celsius to about 400 degrees Celsius for less than or equal to about 36 hours.

27.-28. (canceled)

29. The method of claim 17, wherein the carbonizing comprises carbonizing the stabilized polymer-CNT fiber or film in an inert environment and/or wherein the carbonizing comprises carbonizing the stabilized polymer-CNT fiber or film at about 500 degrees Celsius to about 1800 degrees Celsius for less than or equal to about 2 hours.

30.-31. (canceled)

32. The method of claim 18, wherein the graphitizing comprises graphitizing the carbonized polymer-CNT fiber or film in a non-nitrogen-containing inert environment and/or wherein the graphitizing comprises graphitizing the carbonized polymer-CNT fiber or film at about 1800 degrees Celsius to about 2800 degrees Celsius for less than or equal to about 1 hour.

33.-35. (canceled)

36. The method of claim 16, wherein the CNT in the carbon fiber or film are exfoliated.

37. The method of claim 16, wherein the carbon fiber or film comprises a crystallized graphitic region radially extending about 0.34 nanometers to about 50 nanometers from a wall of each CNT.

38. The method of claim 37, wherein the crystallized graphitic region radially extends at least about 2 nanometers from the wall of each CNT.

39.-63. (canceled)

64. A method of making a carbon fiber or film, the method comprising:
contacting carbon nanotubes (CNT) with an acrylonitrile-containing polymer to form a polymer-CNT dope;
extruding the polymer-CNT dope to form a polymer-CNT fiber or film precursor;
drawing the polymer-CNT fiber or film precursor to form a drawn polymer-CNT fiber or film;
stabilizing the drawn polymer-CNT fiber or film; and
carbonizing the stabilized fiber or film effective to produce a carbon fiber or film having a crystallized graphitic region radially extending about 0.34 nanometers to about 50 nanometers from a wall of each CNT.

65. The method of claim 64, further comprising graphitizing the carbonized polymer-CNT fiber or film.

66.-67. (canceled)

68. The method of claim 64, wherein the polymer-CNT dope comprises about 1 weight percent CNT based on a weight of the acrylonitrile-containing polymer.

69. (canceled)

70. The method of claim 68,
wherein the carbonizing the stabilized film is effective to produce a carbon fiber or film having at least a 0.5 GPa greater tensile strength and at least a 50 GPa greater tensile modulus than a carbon film produced without the CNT.

71. (canceled)

72. A carbon fiber or film formed from carbon nanotubes (CNT) and an acrylonitrile-containing polymer, the carbon fiber or film comprising:
an average cross-sectional dimension of about 50 nanometers to about 50 micrometers; and
a crystallized graphitic region radially extending about 0.34 to about 50 nanometers from a wall of each CNT.

73. The carbon fiber or film of claim 72, wherein the crystallized graphitic region radially extends at least about 2 nanometers from the wall of each CNT.

74.-78. (canceled)

79. The carbon fiber or film of claim 72, wherein the CNT in the carbon fiber or film are exfoliated.

80. The carbon fiber or film of claim 72, wherein the carbon fiber or film has an electrical conductivity at least 25% higher than that of a carbon fiber or film comprising no CNT.

81. The carbon fiber or film of claim 72, wherein the carbon fiber or film comprises a tensile strength at least about 0.5 GPa greater than a carbon fiber or film formed without the CNT.

82. The carbon fiber or film of claim 72, wherein the carbon fiber or film comprises a tensile modulus at least about 50 GPa greater than a carbon fiber or film formed without the CNT.

83. The carbon fiber or film of claim 72, wherein the carbon fiber or film is optically transparent.

84.-87. (canceled)

88. A method of making a carbon fiber or film, the method comprising:
contacting graphite sheets with an acrylonitrile-containing polymer to form a polymer-graphite sheet dope;
gel-extruding the polymer-graphite sheet dope to form a polymer-graphite sheet fiber or film precursor;
drawing the polymer-graphite sheet fiber or film precursor to form a drawn polymer-graphite sheet fiber or film; and
stabilizing the drawn polymer-graphite sheet fiber or film.

89. The method of claim 88, further comprising carbonizing the stabilized polymer-graphite sheet fiber or film.

90. The method of claim 89, further comprising graphitizing the carbonized polymer-graphite sheet fiber or film.

91. A carbon fiber or film formed from graphite sheets and an acrylonitrile-containing polymer, the carbon fiber or film comprising:
an average cross-sectional dimension of about 50 nanometers to about 50 micrometers; and
a crystallized graphitic region extending about 0.34 to about 50 nanometers from a surface of each graphite sheet.

92. The carbon fiber or film of claim 91, wherein the crystallized graphitic region extends at least about 2 nanometers from the surface of each graphite sheet.

93. The carbon fiber or film of claim 91, wherein the graphite sheets in the carbon fiber or film are exfoliated.

94. The carbon fiber or film of claim 91, wherein the carbon fiber or film has an electrical conductivity at least 25% higher than that of a carbon fiber or film comprising no graphite sheets.

95. The carbon fiber or film of claim 91, wherein the carbon fiber or film comprises a tensile strength at least about 0.5 GPa greater than a carbon fiber or film formed without the graphite sheets.

96. The carbon fiber or film of claim 91, wherein the carbon fiber or film comprises a tensile modulus at least about 50 GPa greater than a carbon fiber or film formed without the graphite sheets.
